(19) United States
(12) Patent Application Publication
(10) Pub. No.: US 2005/0040183 A1
(43) Pub. Date: Feb. 24, 2005

(54) Method and device for transporting a flowable building material

(76) Inventor: Sven Treffert, Mainhardt (DE)

Correspondence Address: SHLESINGER, ARKWRIGHT & GARVEY LLP, 3000 South Eads Street, Arlington, VA, 22202, US

(21) Appl. No.: 10/868,348

(22) Filed: Jun. 16, 2004

Related U.S. Application Data
(63) Continuation of application No. PCT/EP02/14204, filed on Dec. 13, 2002.

(30) Foreign Application Priority Data
May 3, 2002 (DE) 202 07 274.6
Dec. 16, 2001 (EP) 01 129 925.2

(51) Int. Cl. B67D 5/62

(52) U.S. Cl. 222/146.2

(57) ABSTRACT

Method and device for transporting flowable building materials which are flowable in a heated state. A pump and a pipe connected to the pump may be provided. The pump and the pipe may be heated by at least one heating device.

### CROSS-REFERENCE TO RELATED APPLICATIONS

This application is a continuation of U.S. Application No. PCT/EP02/14204, filed Dec. 13, 2002, which claims the priority of German Application No. 202 07 274.6, filed May 3, 2002, and which U.S. Application No. PCT/EP02/14204 claims the priority of European Patent Application No. 01 129 925.2, filed Dec. 16, 2001, and each of which is incorporated herein by reference.

### FIELD OF THE INVENTION

The invention relates to a process and an apparatus for conveying construction materials which are flowable in their heated state. The invention also relates to a pump and a pipe for carrying out the process according to the invention.

### BACKGROUND OF THE INVENTION

In the construction industry a plurality of building materials are used which can basically be divided into natural and artificial building materials. In the construction of apartment buildings, in particular, asphalt or pourable asphalt is used as a flooring compound as it is non-flammable and provides good soundproofing. Pourable asphalt is a mixture and consists of about 8 to 10% bitumen and about 90 to 92% minerals with a particle size of 5 to 11 mm.

A disadvantage of pourable asphalt is that it has to be used in a liquid or flowable state and for this it has to be at a temperature of about 250° C. The hot pourable asphalt mass therefore has to be conveyed to the building site as quickly as possible in asphalt boilers and then has to be taken directly to the place of installation in the building without the compound cooling too much.

Currently, it is predominantly transported around the building site in wooden vessels such as wooden buckets or wooden crates as transporting units. These are usually carried to the place of use by means of a carrying yoke. In addition, sloping hoists with suitable platforms are used to convey the wooden units to the particular window of the building under construction. However, for a considerable part of the distance the wooden containers have to be carried by hand. This is very time-consuming and strenuous, as the person responsible has to carry the heavy, hot wooden container to the place of installation quickly before the asphalt contained therein has cooled down too.

### OBJECTS AND SUMMARY OF THE INVENTION

In the light of this, a process for conveying construction materials which are flowable in the heated state is proposed wherein a pump and a pipe connected to this pump are provided, and the pump and the pipe are heated.

The pump is preferably provided in the vicinity of the container in which the supply of hot asphalt is kept and conveys it directly to the place of use through the pipe connected thereto. If the asphalt is delivered by lorry it is possible to drive the lorry right up to the pump or, in the case of a mobile pump, to move the latter to the lorry and connect it up.

As both the pump and the pipe are heated, it is possible to prevent the asphalt or the construction material being conveyed from cooling down too much. The construction material is thus taken directly to the place of use in a workable state.

Tests have shown that good results can be achieved with pipe lengths of up to 50 m and over a height of up to 30 m. However, the process according to the invention can also be used with longer pipes and bridging greater differences in height. The power of the pump, which is able to both pump out and suck in, simply has to be matched to the length of the pipe.

At certain times, preferably at the end of a working day, it must be ensured that the pump and conveying pipe are cleaned. This can be done, for example, using a suitable cleaning fluid and/or a cleaning object, such as a ball, for example, a so-called scraper, which can be forced or sucked through the pipe by pump action or by air pressure.

Advantageously, a common heater is provided for heating the pump and the pipe. The heater used may be, for example, a bar burner which initially heats the pump. The exhaust air formed as the pump is heated is used to heat the pipe.

Preferably, gaseous and/or liquid heat carriers are used to heat the pump and the pipe. These heat carriers are usually passed through heating channels which surround the pipe and the pump. Another possibility is to heat the pump and/or pipe electrically, e.g. using electric heaters. If electric heaters are used, a unit for controlling or regulating the temperature is preferably provided.

With the process according to the invention it is possible to maintain flowable construction materials at a substantially constant temperature and even to convey these materials upwards.

The apparatus according to the invention for conveying construction materials which are flowable in the heated state comprises a pump and a pipe connected to this pump. The pump and the hose are heatable by means of at least one preferably electrically operated heater.

The pipe used may be a tube or a hose, e.g. made of a flexible heat-resistant material. When choosing the material it is important to note that it has to withstand temperatures of from 220° C. to 300° C. A special steel alloy may also be used as the material.

It is advantageous to use a common heater to heat both the pump and the pipe. In one embodiment of the apparatus according to the invention this common heating apparatus is a bar-type burner which is used initially to heat the pump while the pipe is heated by the exhaust air produced on heating the pump.

Preferably, electrical heaters are provided for heating the apparatus according to the invention.

The pump according to the invention serves to deliver materials which are flowable in the heated state, and can be heated by a heater. Heating channels are preferably provided for this purpose. These heating channels ensure that the construction material contained in the pump does not cool off too much. It may optionally be necessary to pre-heat the pump before filling it with the construction material which is to be conveyed. The pump can be used to pump the construction material into the pipe provided or to suck up material contained in the pipe.

According to one embodiment of the invention the pump builds up the pressure needed for conveying the construction materials with a worm conveyor and is thus a so-called worm conveyor pump which usually has an endless worm or screw conveyor cut into a cylindrical shaft, the worm conveyor being used to transport flowable materials.

The worm conveyor may be directly heatable, i.e. by passing a heat carrier through the worm conveyor, for example, or the latter may contain an electrical heating element. Alternatively, electrical heating elements or heat carrier lines may run in or over the walls of the pump.

In an alternative embodiment the necessary pressure is built up by a piston or a stopper, while the stopper or piston may be adapted to be forced right through the pipe.

Advantageously the worm conveyor according to the invention converges conically or tapers at one of its ends, specifically at the end which is to be connected to the pipe during use, this connecting end being matched in diameter to the attached pipe.

The pump according to the invention preferably comprises an inner pipe and an outer pipe which contains it, the worm conveyor being mounted in the inner pipe and heating elements being accommodated in or on the outer pipe. This ensures easier access to the pump for maintenance.

The pipe according to the invention can also be heated by means of a heater provided for this purpose. Heating channels may be provided, surrounding the pipe. The heat carrier provided is then passed through these channels, for example, ensuring that the construction material contained in the pipe does not cool down.

The heating channels are preferably applied in a spiral around the pipe, as is necessary for mobility or flexibility in a pipe made of a flexible material, e.g. a hose. If for example the pipe is in the form of a spiral hose, heating elements, e.g. electric heat conductors, may be provided extending in a similar configuration to the hose. This results in a smaller radius of bending of the hose.

According to one feature of the invention an end cap is provided on the pipe for the removal of exhaust air. A regulator which regulates the speed of the pump during delivery and intake may also be provided in the end cap.

Preferably, the pipe is enclosed in an insulating layer. The heating elements are then located between the pipe wall and the insulating layer.

A protective layer protects against mechanical influences and may provide additional insulation.

According to one feature of the pipe according to the invention it is made up of sections which can be connected to one another. These sections are preferably to be heated separately. Expediently, each section has a temperature sensor, e.g. a PT-100, which detects the temperature in this section. A preferably central regulating device, optionally connected via a bus system, then allows simultaneous or parallel temperature regulation for each of the sections.

The sections may be from 1 to 10 m long, for example.

The pipe according to the invention preferably has an inner and an outer hose or an inner and an outer tube. The inner hose is expediently constructed as a corrugated or spiral hose made of stainless steel. The outer hose acts as insulation. In addition, it may be enveloped in a protective jacket.

Between the inner and outer hoses are typically found the heating pipes or heating elements. A temperature sensor rests directly on the inner hose.

The use according to the invention envisages the use of the apparatus according to the invention for conveying flowable construction materials such as pourable asphalt, for example.

Further advantages and embodiments of the invention will become apparent from the specification and the accompanying drawings.

It will be understood that the features mentioned above and those still to be described hereinafter may be used not only in the particular combination specified but also in other combinations or on their own, without departing from the scope of the present invention.

The invention is illustrated in the drawings by means of exemplifying embodiments and is hereinafter explained more fully with reference to the drawings.

### BRIEF DESCRIPTION OF THE DRAWINGS

FIG. 1 shows a preferred embodiment of the apparatus according to the invention in diagrammatic representation,

FIG. 2 shows another preferred embodiment of the apparatus according to the invention,

FIG. 3 shows a preferred embodiment of the pipe according to the invention in cross section,

FIG. 4 shows a detail of a pipe according to the invention,

FIG. 5 shows a preferred embodiment of the pump according to the invention in diagrammatic representation,

FIG. 6 shows another preferred embodiment of the pump according to the invention,

FIG. 7 shows a detail of another preferred embodiment of a pump according to the invention, and

FIG. 8 shows another preferred embodiment of the apparatus according to the invention.

### DETAILED DESCRIPTION OF THE INVENTION

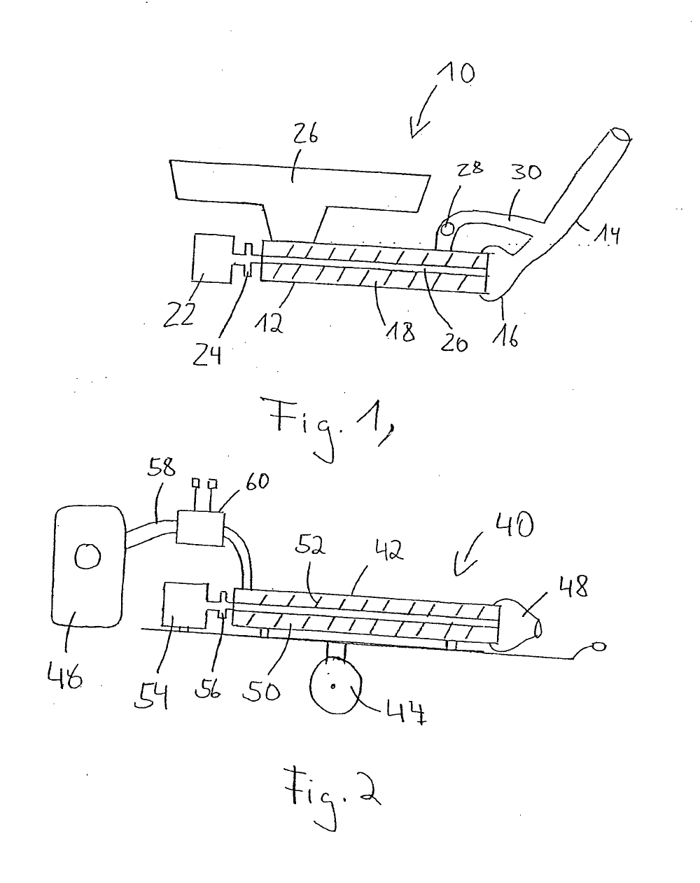

In FIG. 1, a preferred embodiment of the apparatus according to the invention is diagrammatically shown, generally designated 10. The drawing shows a pump 12 and a pipe 14 connected to the pump 12 via a connector 16.

The pump 12 is constructed as a worm conveyor pump 12 with a cylindrical shaft 18 and a worm conveyor 20 or screw conveyor 20 rotatably mounted therein. The worm conveyor 20 is driven by a drive motor 22, or by an electric motor, via a bearing block 24, i.e. rotated about its longitudinal axis. The material to be conveyed is introduced into the pump 12 through a hopper or funnel 26 and from there is forced towards the connector 16 and the pipe 14 by the rotation of the worm conveyor 20. The pipe 14 ends at the place where the material or construction material is to be worked, which means that the material no longer has to be transported manually.

In order to allow this to happen with a construction material which has to be heated up, in the apparatus 10 shown there is a heater 28 which heats both the pump 12 and also the pipe 14 via a feed line 30. This is preferably done by means of a heat carrier which supplies the heat generated by the heater 28 to the pump 12 and the pipe 14.

Usually, the pump 12 is heated first and the exhaust air produced is used to heat the pipe 14 via the feed line 30.

FIG. 2 shows another embodiment of the apparatus according to the invention. The apparatus 40 has a pump 42 of mobile construction, i.e. it can be moved along on a wheel 44 or wheels 44 to a tank 46. The mobile pump station 42 is connectable to a pipe (not shown) via a connector 48.

The pump 42 comprises an elongated cylindrical shaft 50 and a worm conveyor 52 located therein which is to be driven by a motor 54 via a bearing block 56. In the embodiment shown the motor 54 and the bearing block 56 are movable together with the pump 42. However, it is certainly possible for only the pump 42 to be mobile and for the motor 54 and/or the bearing block to be fixedly mounted in one place.

The construction material contained in the tank 46 is let into the pump 42 through a supply line 58 and an actuating device 60. The actuating device 60 initiates or controls this process. The supply line 58 may also be heatable.

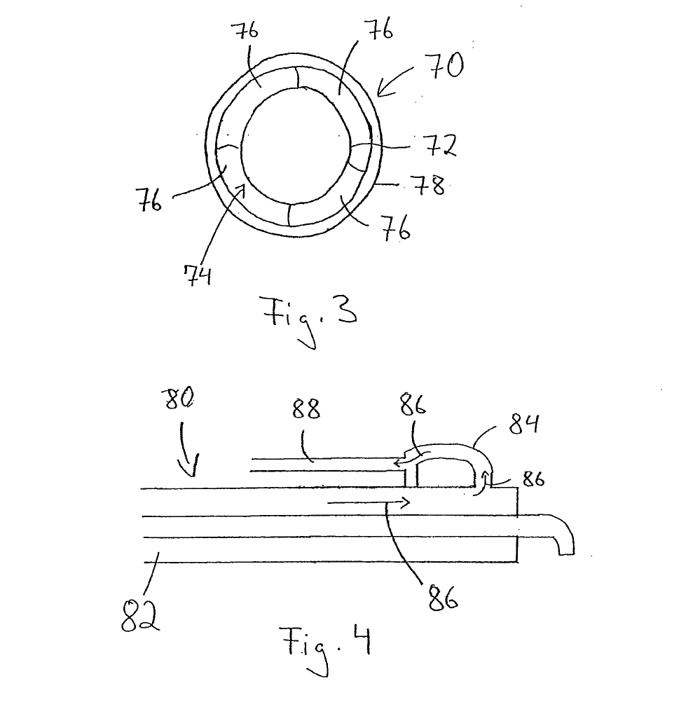

FIG. 3 shows a cross section through an advantageous embodiment of a pipe according to the invention which is designated 70. A wall 72 defines the cross sectional area of the pipe 70 through which the typically viscous material to be conveyed is pumped. The wall 72 is surrounded by a heating jacket 74 which is in turn made up of four heating channels 76 which totally surround the wall 72. A heat carrier or heating medium is conveyed through these heating channels 76 which preferably run in a spiral. The heat carrier may be, for example, air, oil, particularly thermal oil, or water.

The pipe 70 is surrounded by an insulating layer 78 which ensures that the heat energy is not excessively given off to the surroundings.

In the embodiment shown the heating jacket 74 is wrapped around the wall 72 of the pipe 70. However, it is also thoroughly possible for heating pipes to be provided already in the wall 72 of the pipe 70, through which the heat carrier is conveyed. Another possibility is to provide electrical heating elements in or on the wall 72 of the pipe 70.

FIG. 4 shows a detail of a pipe 80, specifically the end portion. The Figure shows a heating jacket 82, in which heating channels are provided, surrounding the pipe 80. A handle 84 allows a workman to bring the end of the pipe directly to the place of use. This handle 84 is hollow so that the exhaust air can be recycled back through an exhaust pipe 88, as shown by arrows 86. A sealed system can thus be produced.

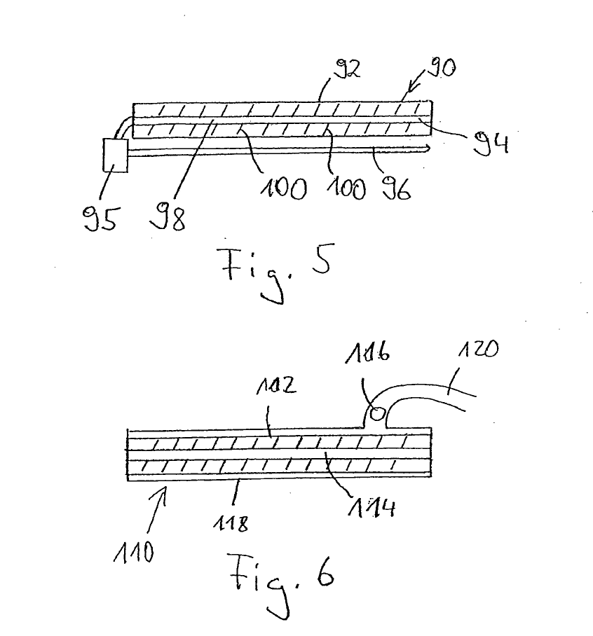

FIG. 5 shows a pump 90, namely a worm conveyor pump 90. This is made up of a shaft 92 and a worm conveyor 94. A heater 95 is also shown. Underneath the pump 90 and along it runs a heating element 96 actuated by the heater 95 which ensures that the pump 90 can be heated over its entire length.

The worm conveyor 94 comprises a shaft 98 and blades 100 mounted on the shaft 98. The shaft 98 which defines the longitudinal axis of the worm conveyor 94 may be of hollow construction so that a heat carrier can be passed through it and in this way the worm conveyor 94 can be heated directly. According to another alternative, an electrical heating element is provided in the shaft 98. A heating element of this kind may of course also be installed in or on the wall of the shaft 92.

FIG. 6 shows another pump 110 which again is made up of a shaft 112 and a worm conveyor 114. Alternatively to the worm conveyor pump 110 shown here, a vane pump may also be used in the apparatus according to the invention.

FIG. 6 also shows a heating apparatus 116 which is connected to a heating jacket 118. This heating jacket completely surrounds the shaft 112 of the pump 110. Heating channels may in turn be provided in the heating jacket 118.

The pump (110) is safely heated in this way. The exhaust air produced can be fed through a feed line 120 into a pipe (not shown).

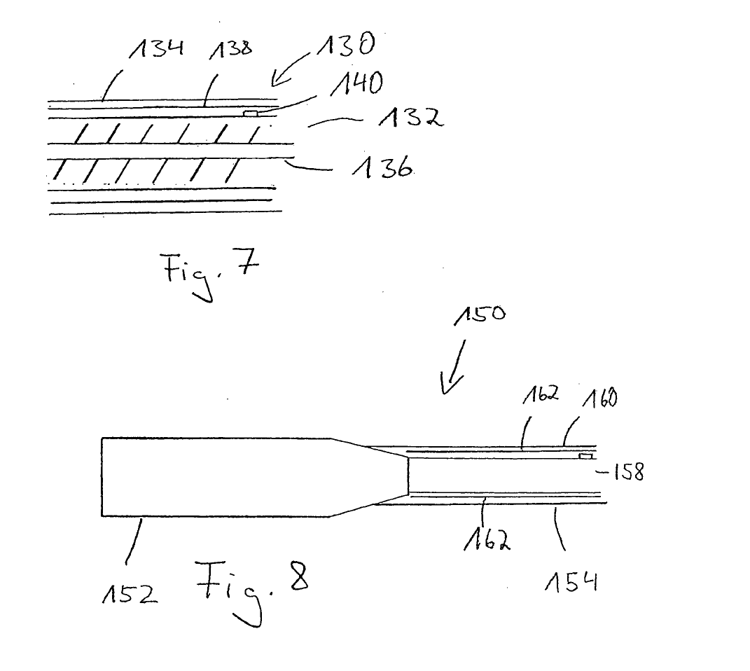

FIG. 7 shows a detail of another pump according to the invention, generally designated 130. It can be seen that this pump 130 comprises an inner tube 132 and an outer tube 134, the inner tube 132 being received within the outer tube 134.

In the inner tube 132 is mounted a worm conveyor 136 for conveying pourable asphalt contained in the pump.

In or on the walls of the outer tube 134 are heating elements 138, in this case electrical heating elements 138, which enable the pourable asphalt contained in the pump to be maintained at a constant temperature. This temperature is monitored, by a temperature sensor 140, e.g. a PT-100.

FIG. 8 diagrammatically shows another apparatus 150 according to the invention. It comprises a pump 152 and a pipe 154 connected thereto.

It can be clearly seen that the pump 152, in this case a worm conveyor pump, converges conically towards one of its ends. This conically convergent end 156 serves for connection to the pipe 154. The worm conveyor in the pump 152 may be shaped accordingly.

The pipe 154 comprises an inner hose 158 and an outer hose 160. Between these two are provided heating elements 162 which are preferably arranged close to the inner hose 158.

Directly mounted on the inner hose 158 is a temperature sensor 164 which can be used to monitor and regulate the temperature in the inner hose 158 and hence the temperature of the construction material conveyed.

There are various possible ways of heating the pump according to the invention and the pipe according to the invention. The procedures illustrated are only a selection and obviously may be combined with one another in any desired manner.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. A process for conveying a construction material of the type which is flowable in a heated state, comprising:
a) providing a pump;
b) providing a pipe connected to the pump;
c) heating the pump and the pipe; and
d) pumping the construction material of the type which is flowable in a heated state through the pump and the pipe heated in the step of heating the pump and the pipe.

2. A process according to claim 1, wherein:
a) a common heating device is provided for heating the pump and the pipe.

3. A process according to claim 2, wherein:
a) the common heating device is a bar-type burner with which the pump is heated to begin with; and
b) the pipe is heated with the exhaust air produced during the heating of the pump.

4. A process according to claim 1, wherein:
a) at least one of a gaseous and a liquid heating medium is used to heat the pump and the pipe.

5. A process according to claim 4, wherein:
a) heating channels are provided; and
b) the at least one of a gaseous and liquid heating medium is passed through the heating channels for the heating.

6. Apparatus for conveying a construction material of the type which is flowable in a heated state, comprising:
a) a pump;
b) a pipe connected to the pump;
c) at least one heating device being provided for heating the pump and the pipe; and
d) the pump being configured and disposed for pumping the construction material of the type which is flowable in a heated state through the pump and the pipe heated in the step of heating the pump and the pipe.

7. Apparatus according to claim 6, wherein:
a) a common heating device is provided for heating the pump and the pipe.

8. A pump for conveying construction materials of the type which are flowable in a heated state, the pump comprising:
a) a pump configured for pumping construction materials of the type which are flowable in a heated state; and
b) a heating device provided for heating the pump sufficiently to heat construction materials of the type which are flowable in a heated state, when, in use, such construction materials are to be pumped by the pump.

9. A pump according to claim 8, wherein:
a) heating channels are provided for heating the construction materials which are to be conveyed by the pump.

10. A pump according to claim 8, wherein:
a) a worm conveyor is provided, the worm conveyor being configured for building up the pressure needed to convey the construction materials.

11. A pump according to claim 10, wherein:
a) the worm conveyor is constructed so that a heating medium can be passed through it.

12. A pump according to claim 10, wherein:
a) the worm conveyor converges conically at one of its ends.

13. A pump according to claim 10, wherein:
a) the pump includes an inner tube and an outer tube.

14. A pipe for conveying construction materials which are flowable in a heated state, comprising:
a) a hollow section; and
b) a heating device is provided for heating construction materials conveyed in the hollow section of the pipe that are flowable in the heated state.

15. A pipe according to pipe 14, wherein:
a) heating channels are provided surrounding the pipe.

16. A pipe according to claim 14, wherein:
a) the hollow section of the pipe is made up of sections which are connectable to one another and which are configured to be heated separately.

17. A process of using an apparatus for conveying construction materials of the type which are flowable in a heated state, in accordance with claim 6.
